(19) United States
(12) Patent Application Publication
(10) Pub. No.: US 2009/0024787 A1
(43) Pub. Date: Jan. 22, 2009

(54) Data writing method and apparatus

(75) Inventor: Keun-soo Yim, Yongin-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 12/010,199

(22) Filed: Jan. 22, 2008

(30) Foreign Application Priority Data
Jul. 16, 2007 (KR) 10-2007-0071370

(51) Int. Cl. G06F 12/02

(52) U.S. Cl. 711/103; 711/E12.008

(57) ABSTRACT

Provided are a data writing method and apparatus. In the data writing method, data that is to be written to a first storage medium and the address of the first storage medium are received, data is read from the address of the first storage medium, the received data is compared with the read data, and then the received data is stored in either the first storage medium or a second storage medium, depending on the comparison result. Accordingly, it is possible to reduce the time required for data writing and to increase the lifetime of a storage medium.

### CROSS-REFERENCE TO RELATED PATENT APPLICATIONS

This application claims the benefit of Korean Patent Application No. 10-2007-0071370, filed on Jul. 16, 2007, in the Korean Intellectual Property Office, the disclosure of which is incorporated herein in its entirety by reference.

### BACKGROUND OF THE INVENTION

1. Field of the Invention

The present invention relates to a data writing method and apparatus, and more particularly, to a data writing method and apparatus for improving the writing performance of flash memory.

2. Description of the Related Art

A data storage device using flash memory has been extensively used in embedded systems or mobile systems. A storage device that uses flash memory is a type of Electrically Erasable Programmable Read-Only Memory (EEPROM), and performs not only a read operation and a write operation but also an erase operation prior to the write operation. The storage device using flash memory is disadvantageous in that it can perform the read operation at high speeds but performs the write operation and the erase operation at low speeds.

In detail, an input/output operation is performed on a storage device using flash memory in units of pages (2 or 4 bytes long in the case of NOR flash memory, and 512 bytes long or 2 Kbytes long in the case of NAND flash memory), and the erase operation is performed on the storage device in units of blocks (128 Kbytes long in the case of NOR flash memory, and 16 or 64 Kbytes long in the case of NAND flash memory). About 400 μs is incurred to use 2 bytes in the case of the NOR flash memory, and about 300 μs is incurred to use 2 Kbytes in the case of the NAND flash memory. A time of 2 ms is needed to perform the erase operation on each of blocks of the storage medium.

Also, an erase-before-write operation needs to be performed on a storage device such as flash memory because of its physical characteristics. The erase-before-write operation means that the write operation is performed on a page after data stored in a block to which the page belongs is erased using the erase operation. Also, in this case, a total number of times that the write operation can be performed on each block is generally limited to a hundred thousand, and thus the lifetime of the flash memory is limited.

As described above, the lifetime of storage devices, such as flash memory, on which a total number of times that the write operation can be performed is limited, may be greatly reduced if the amount of data to be written is large or the write operation is performed frequently. In particular, the higher the density of a storage device, the more a total number of times the write operation can be performed is limited. Thus a total number of times the write operation is to be performed needs to be reduced so as to increase the lifetime of a storage device.

Conventionally, the Wear-Leveling technique has been used in order to perform the write operation on all address regions an equal number of times so that the erase operation or the write operation can reach the uppermost limit in all the address regions at almost the same time. The Wear-Leveling technique has been introduced by Eran Gal and Sivan Toledo [“Algorithms and data structures for flash memories”, ACM Computing Surveys, Vol. 37, Issue 2, June 2005]. In the Wear-Leveling technique, the total number of times the erase operation has been performed on each block is recorded, and a block on which the total number of times the erase operation has been performed is less than on the other blocks is allocated as a black block, thereby equalizing the total numbers of times that the erase operation is to be performed on all the blocks.

However, this technique does not serve to reduce the total number of times that the erase operation or the write operation is to be performed on a storage device, and therefore there is a restriction to not only increasing the lifetime of the storage device but also to improving the speed of writing data to the storage device.

### SUMMARY OF THE INVENTION

The present invention provides a data writing method and apparatus capable of increasing the lifetime of a storage medium and reducing a time required for data writing.

The present invention also provides a computer readable recording medium having recorded thereon a computer program for executing the above method.

According to an aspect of the present invention, there is provided a method of writing data, the method comprising: receiving data that is to be written to a first storage medium, and an address of the first storage medium; reading data stored at the address of the first storage medium; comparing the received data with the read data; and storing the received data in either the first storage medium or a second storage medium, depending on a comparison result; wherein the first storage medium is a non-volatile storage medium supporting a block unit input/output operation and the second storage medium is the non-volatile storage medium supporting a unit input/output operation, wherein the unit is smaller than the block unit.

According to another aspect of the present invention, there is provided a computer readable recording medium having recorded thereon a computer program for executing the above method of writing data.

According to another aspect of the present invention, there is provided a method of reading data, the method comprising: if a request for data reading at an address is received from a host, reading data from a block of a first storage medium, which contains the address; determining whether a second storage medium contains a sub block of the block containing the address; reading data from the sub block of the second storage medium, depending on a determination result; and combining the data from the first storage medium with the data read from the second storage medium and then providing a combination result to the host; wherein the first storage medium is a non-volatile storage medium supporting a block unit input/output operation and the second storage medium is the non-volatile storage medium supporting a unit input/output operation, wherein the unit is smaller than the block unit.

According to another aspect of the present invention, there is provided an apparatus for writing data, comprising: an input unit receiving data that is to be written to a first storage medium, and an address of the first storage medium; a data reading unit reading data from the address of the first storage medium; a comparison unit comparing the received data with the read data; and a data writing unit writing the received data to either the first storage medium or a second storage medium, depending on a comparison result; wherein the first storage medium is a non-volatile storage medium supporting a block unit input/output operation and the second storage medium is the non-volatile storage medium supporting a unit input/output operation, wherein the unit is smaller than the block unit.

According to another aspect of the present invention, there is provided an apparatus for reading data, comprising: if a request for data reading at an address is received from a host, a first data reading unit reading data from a block of a first storage medium, which contains the address; a determination unit determining whether a second storage medium contains a sub block of the block containing the address; a second data reading unit reading data from the sub block of the second storage medium, depending on a determination result; and a data combining unit combining the data read from the first storage medium with the data read from the second storage medium and then providing the combined result to the host; wherein the first storage medium is a non-volatile storage medium supporting a block unit input/output operation and the second storage medium is the non-volatile storage medium supporting a unit input/output operation, wherein the unit is smaller than the block unit.

In a data writing method according to the present invention, already stored data is read from an address of a first storage medium to which input data is to be written, and only the difference between the written data and the read data is written to a second storage medium, thereby reducing a time required for data writing and increasing the lifetime of the storage media.

### BRIEF DESCRIPTION OF THE DRAWINGS

The above and other features and advantages of the present invention will become more apparent by describing in detail exemplary embodiments thereof with reference to the attached drawings in which:

FIG. 1A is a block diagram of a data writing and reading apparatus according to an embodiment of the present invention;

FIG. 1B is a block diagram of a data writing apparatus according to an embodiment of the present invention;

FIG. 1C is a block diagram of a data reading apparatus according to an embodiment of the present invention;

FIG. 2 is a block diagram of a computer system employing a data writing apparatus, according to an embodiment of the present invention;

FIG. 3 is a diagram illustrating a method of combining data when a second block consists of 4 sub blocks, according to an embodiment of the present invention;

FIG. 4 is a flowchart illustrating a data writing method according to an embodiment of the present invention;

FIG. 5 is a block diagram of a data writing apparatus according to another embodiment of the present invention;

FIG. 6 is a flowchart illustrating a data writing method according to another embodiment of the present invention;

FIG. 7 is a flowchart illustrating a data reading method according to an embodiment of the present invention; and

FIG. 8 is a diagram comparing a total length of time needed to perform a write operation when using a data writing method according to the present invention with a total length of time needed when using a conventional method.

### DETAILED DESCRIPTION OF THE INVENTION

Exemplary embodiments of the present invention will be described in detail with reference to the accompanying drawings.

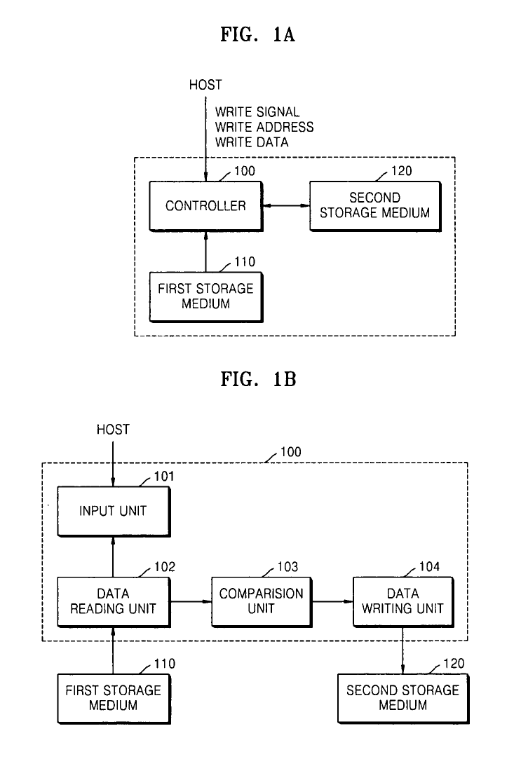

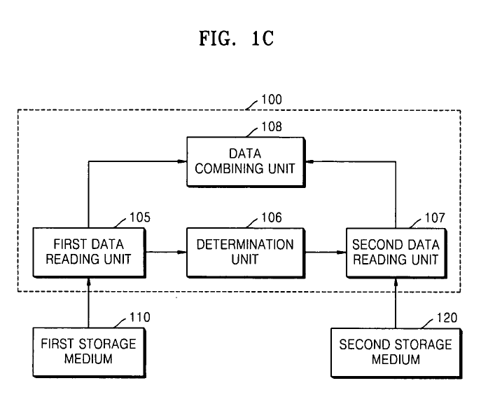

FIG. 1A is a block diagram of a data writing and reading apparatus according to an embodiment of the present invention. Referring to FIG. 1A, the apparatus includes a controller 100, a first storage medium 110 and a second storage medium 120. FIG. 1B is a block diagram of a data writing apparatus according to an embodiment of the present invention. Referring to FIG. 1B, the controller 100 includes an input unit 101, a data reading unit 102, a comparison unit 103 and a data writing unit 104. FIG. 1C is a block diagram of a data reading apparatus according to an embodiment of the present invention. Referring to FIG. 1C, the controller 100 includes a first data reading unit 105, a determination unit 106, a second data writing unit 107 and a data combination unit 108. In the current embodiment, a non-volatile storage medium supporting a block unit input/output operation such as flash memory is used as the first storage medium 110 and a non-volatile storage medium supporting a unit input/output operation, wherein the unit is smaller than the block unit, is used as the second storage medium 120. In particular, if such a data writing apparatus is used within a Consumer Electronics (CE) device, a multi-level cell (MLC) NAND flash memory may be used as the first storage medium 110 and a single-level cell (SLC) NAND flash memory may be used as the second storage medium 120.

Referring to FIG. 1B, the input unit 101 receives a write signal, a write address, and write data from a host.

If receiving the write signal and the write address from the host, the data reading unit 102 reads data stored at the write address of the first storage medium 110 in response to the write signal, and also, reads all data stored in a first block corresponding to the write address. In this case, if a NAND flash memory is used as the first storage medium 110, the size of the first block is 16 or 64 Kbytes long.

After reading the data from the first block, the comparison unit 103 compares the read data with the write data received from the host in order to determine if there is a difference therebetween. To this end, the read data and the write data are divided into N sub blocks, read data from each of the sub blocks is compared with the write data of each of the sub blocks in order to determine whether the read data is the same as the write data, and then a sub block, read data of which is different from the write data, is detected. In this case, one of the following three methods may be used in order to determine whether read data and write data are the same in units of sub blocks.

A first method is a simple comparison method in which all pieces of data belonging to each sub block are compared with one another. That is, the comparison is performed in units of sub blocks.

A second method is a selective comparison method in which if a data difference is detected during comparison of data belonging to a sub block, the comparison of the other data in the sub block is skipped, and then the comparison is performed on a subsequent sub block.

A third method is a comparison method using Error Checking and Correcting (ECC) or Cyclic Redundancy Checking (CRC), in which checksums of respective data belonging to a sub block are generated and the checksums are compared with one another. That is, whether all data stored in the sub block are different from one another is determined in units of sub blocks. Such a checksum is a type of data fingerprint, and used in order to determine whether all data stored in the sub block is different from one another. In order to generate a checksum, MD5 (Message Digest 5) may be used with respect to data stored in a sub block. MD5 is an algorithm whereby input data is compressed into a 128-bit message, and a standard thereof is specified in IETF (International Engineering Task Force) RFC (Request For Comments) 1321.

Then the comparison unit 103 determines whether detected sub blocks satisfy a partial writing condition. In this case, the partial writing condition is understood as one of the following methods._{—}

In one of the methods, a total number of sub blocks detected must be less than or equal to a threshold. In this case, the threshold means a maximum number of sub blocks on which partial writing can be performed. The smaller the threshold is, the higher the possibility that partial writing can be performed, and the faster a write operation can be performed. Partial writing is not accompanied by an erase operation unlike whole writing, and thus the lifetime of the first storage medium 110 is increased. However, the smaller the threshold is, the more data needs to be stored in the second storage medium 120, and thus a high-capacity memory must be used as the second storage medium 120.

In the other method, a total number of sub blocks detected must be less than or equal to a first threshold, or a total number of a series of sub blocks detected must be less than or equal to a second threshold. That is, even if the total number of sub blocks detected is greater than the first threshold, whole writing is allowed only when the total number of a series of sub blocks detected is greater than the second threshold. If it is determined that a sub block of the first block in which stored data is different from the write data does not satisfy the partial writing condition, the data writing unit 104 performs whole writing on the first block. For example, whole writing is performed by writing the received write data to a blank block of the first storage medium 110 and then changing a mapping table between a logical block number and a physical block number. It is assumed that the logical block number of the write data is 9, and the mapping table reveals that the physical block number corresponding to the logical block number of 9 is 7. Then although the write data is to be written to a 7^{th} block, the write data is written to a 12^{th} block that is a blank block since data has already been written to the 7^{th} block and then the physical block number corresponding to the logical block number of 9 is changed to 12.

If it is determined that a sub block of the first block in which stored data is different from the write data satisfies the partial writing condition, the data writing unit 104 performs partial writing. Partial writing means that data stored in a detected sub block is written to the second storage medium 120. In this case, the data stored in the sub block can be written to the second storage medium 120 together with meta data such as a mask of the sub block. The mask is a parameter used in order to read data from storage media by using a data writing method according to the present invention, and indicates the location of a sub block stored in the second storage medium 120 within a plurality of whole sub blocks. That is, if the first block consists of 4 sub blocks, the mask is 4 bits long, and if a sub block stored in the second storage medium 120 is a third sub block of the first block, the bits of the mask are ‘0010’.

The second storage medium 120 must be a storage medium in which data can be written in a unit smaller than each sub block. For example, the second storage medium 120 must be a storage medium in which data can be written or read in units of bytes or words. Also, the second storage medium 120 can be a non-volatile RAM such as MRAM (Magnetoresistive RAM), FRAM (Ferroelectric RAM) and PRAM (Phase-change RAM) which provide the same interface as SRAM or DRAM. The second storage medium 120 can be a battery backed RAM which has a battery or a super capacitor embedded in a general SRAM or DRAM. In this case, the battery backed RAM can write data which is in the SRAM or DRAM into the first storage medium 120 by using a super capacitor or a battery when the power-off occurs.

Referring to FIG. 1C, the data reading apparatus receives a read signal and a read address from the host.

After receiving the read signal and the read address from the host, the first data reading unit 105 reads data stored at the read address of the first storage medium 110 in response to the read signal. In this case, the first data reading unit 105 reads all data stored in a second block containing the read address. If the first storage medium 110 is a NAND flash memory, the size of the second block is 16 or 64 Kbytes long.

Then the determination unit 106 determines whether a sub block included in the first block is present in the second storage medium 120, and provides the data read from the first storage medium 110 to the host if it is determined that the sub block is not present. If it is determined that the sub block is present, the second data reading unit 107 reads the data stored in the sub block from the second storage medium 120. Then the data combining unit 108 combines the data read from the first storage medium 110 and the data read from the second storage medium 120 and then provides the combination result to the host.

For data combining, the data read from the second storage medium 120 may be overwritten to the data read from the first storage medium 110.

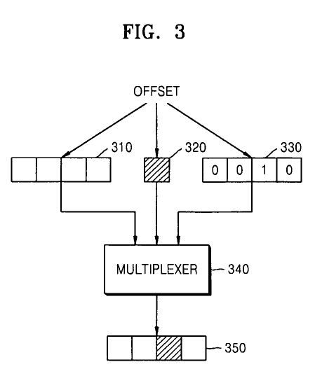

Alternatively, a mask may be used for data combining. FIG. 3 is a diagram illustrating a method of combining data by using a mask if a second block consists of 4 sub blocks.

Referring to FIGS. 1A and 3, data 310 is read from the first storage medium 110 according to a read address received from the host and an offset, and then data 320 and a mask 330 are read from the second storage medium 120. The offset indicates a location of the second block which sub blocks are supposed to occupy. If a bit value of the mask 330 is ‘1’ for the data 310 read from the first storage medium 110 and the data 320 read from the second storage medium 120, a multiplexer 340 outputs data stored in a sub block read from the first storage medium 110. If the bit value of the mask 330 is ‘0’ for the data 310 and the data 320, the multiplexer 340 outputs data read from the second storage medium 120. Then the multiplexer 340 combines the output data and provides the host with the combined data 350.

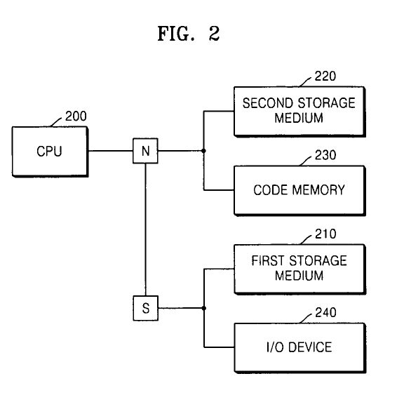

FIG. 2 is a block diagram of a computer system employing a data writing apparatus according to an embodiment of the present invention. Referring to FIG. 2, the computer system includes a central processing unit (CPU) 200, a first storage medium 210, a second storage medium 220, a code memory 230, and an input/output (I/O) device 240. In the current embodiment, flash memory is used as the first storage medium 210. In particular, in the current embodiment, the first storage medium 210 may be an MLC or SLC NAND flash memory and the second storage medium 220 may be ferroelectric random access memory (FRAM), magnetoresistive random access memory (MRAM) or phase-change random access memory (PRAM).

The CPU 200, the first storage medium 210 and the second storage medium 220 respectively correspond to the controller 100, the first storage medium 110 and the second storage medium 120 illustrated in FIG. 1A and FIG. 1B. The first storage medium 210 is connected to the CPU 200 via a South bridge (S), and the second storage medium 220 is connected to the CPU 200 via a North bridge (N).

The code memory 230 generally indicates a main memory employed in a computer system, and the I/O device 240 indicates a serial parallel port connected to a hard disc, an Integrated Drive Electronics (IDE) device, a keyboard, a mouse, and so on.

First, the CPU 200 reads data from the first storage medium 210 according to the address of write data to be written to the first storage medium 210. Specifically, the CPU 200 reads data stored in the address (first address) of write data to be written to the first storage medium 210 from first storage medium 210. In this case, the CPU 200 reads all data stored in a first block containing the first address.

Then the CPU 200 compares the data read from the first block with the write data to be written in order to determine if there is a difference therebetween. To this end, the first block is divided into N sub blocks, compares data read from each of the sub blocks with the write data in order to determine whether they are the same, and then detects a sub block, the data of which is different from the write data. In this case, a method of determining whether the read data is the same with the write data is the same as used in the data writing apparatus illustrated in FIG. 1B.

The CPU 200 determines whether detected sub blocks satisfy a predetermined condition. The predetermined condition indicates a condition for partial writing, which is the same as used in the data writing apparatus illustrated in FIG. 1B.

If the detected sub blocks do not satisfy the predetermined condition, the CPU 200 performs whole writing on the entire first block. If the sub blocks detected satisfy the predetermined condition, the CPU performs partial writing.

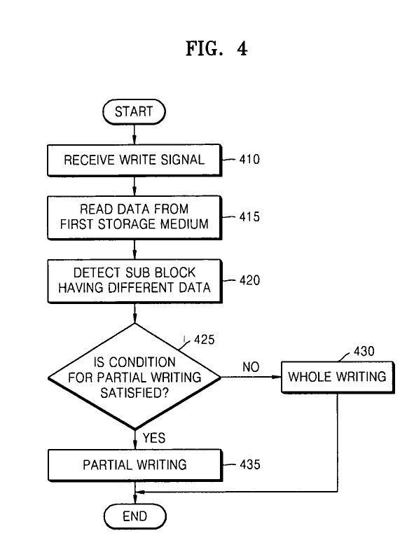

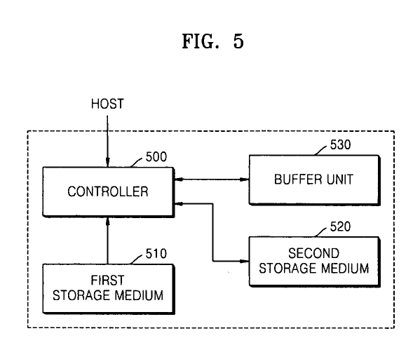

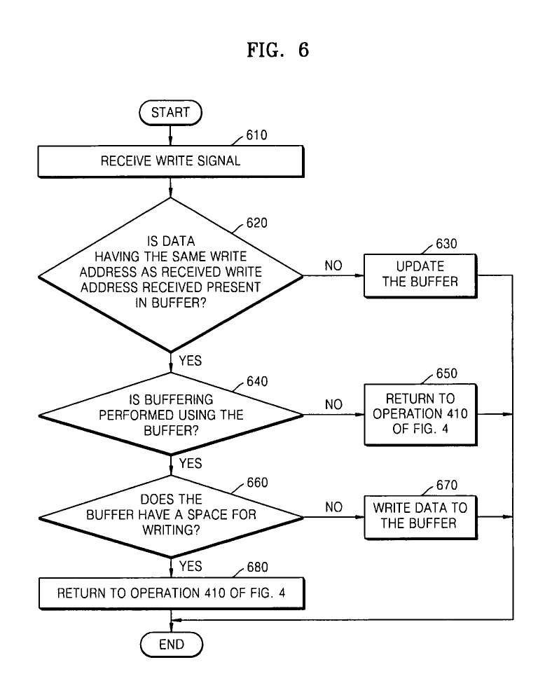

FIG. 4 is a flowchart illustrating a data writing method according to an embodiment of the present invention. Referring to FIG. 4, the data writing method of the present embodiment comprises operations that are sequentially performed by the data writing apparatus illustrated in FIG. 1B. Thus although not described here, the description of the data writing apparatus illustrated in FIG. 1B can be applied to the data writing method of FIG. 4.

Referring to FIG. 4, in operation 410, a controller receives a write signal, a write address, and write data from a host.

In operation 415, the controller reads data stored at the write address of a first storage medium in response to the write signal received in operation 410. In this case, the controller reads all data stored in a first block containing the write address.

In operation 420, after reading all the data stored in the first block, the controller compares the read data with the write data received from the host in order to determine if there is a difference therebetween. To this end, the first block is divided into N sub blocks, the data read from each of the sub blocks in operation 415 is compared with the write data received in operation 410 in order to determine whether the read data is the same as the write data, and then a sub block, the data of which is different from the write data is detected.

In operation 425, the controller determines whether the detection result in operation 420 satisfies a predetermined condition. The predetermined condition means a condition for partial writing, which may be one of the following methods. In one of the methods, a total number of sub blocks detected must be less than or equal to a threshold. In the other method, the total number of the sub block detected must be less than or equal to a first threshold, or a total number of a series of sub blocks detected must be less than or equal to a second threshold.

In operation 430, the controller performs whole writing if the determination result in operation 425 does not satisfy the predetermined condition.

In operation 435, the controller performs partial writing if the determination result in operation 425 satisfies the predetermined condition. Partial writing means that data stored in a detected sub block is written to a second storage medium. In this case, meta data such as a mask may be written to the second storage medium together with the data in the sub block.

In this case, while the controller performs operations 420 and 425 on current write data, it is possible to perform operations 430 and 435 on previous write data by using Direct Memory Access (DMA) and then perform operations 410 and 415 on subsequent write data, thereby performing data writing at high speeds.

FIG. 5 is a block diagram of a data writing apparatus according to another embodiment of the present invention. Referring to FIG. 5, the data writing apparatus includes a controller 500, a first storage medium 510, a second storage medium 520, and a buffer unit 530. As compared to the data writing apparatus of FIG. 1B, the data writing apparatus of FIG. 5 further includes the buffer unit 530 so that data that is likely to be corrected can be temporarily stored in the buffer unit 530, thereby increasing the writing performance of the data writing apparatus. The buffer unit 530 may be MRAM, FRAM, or PRAM, which is a non-volatile memory device or a non-volatile polymer memory.

After receiving a write signal, a write address, and write data from a host, the controller 500 determines whether data having the same write address as the write data is present in the buffer unit 530.

If it is determined that data having the same write address is present, the controller 500 determines whether to perform buffering using the buffer unit 530. In this case, the probability the write address will be corrected is predicted using temporal proximity in the received write address. If the probability the write address will be corrected is high, buffering is determined to be performed using the buffer unit 530. If the probability the write address will be corrected is low, it is determined that buffering is not to be performed using the buffer unit 530.

If it is determined that buffering is to be performed using the buffer unit 530, the controller 500 determines whether the buffer unit 530 has a space to which the write data can be written. If the buffer unit 530 has such a space, the write data is written to the buffer unit 530. If the buffer unit 530 does not have such a space, some pieces of data stored in the buffer unit 530, which are infrequently used, are written using a data writing method according to the present invention. That is, the controller 500 performs whole writing on the first storage medium 510 or partial writing on the second storage medium 520, depending on whether data that is to be written is the same as the data stored in the first storage medium 510.

FIG. 6 is a flowchart illustrating a data writing method according to another embodiment of the present invention. The data writing method of FIG. 6 includes operations that are sequentially performed in the data writing apparatus of FIG. 5. Thus although not described here, the description of the data writing apparatus illustrated in FIG. 5 can be applied to the data writing method of FIG. 6.

Referring to FIG. 6, in operation 610, a controller receives a write signal, a write address, and write data from a host.

In operation 620, the controller determines whether data having the same write address as the write address received in operation 610 is present in a buffer.

In operation 630, if it is determined in operation 620 that data having the same write address is stored in the buffer, the controller updates the data stored in the buffer with the write data received in operation 610.

In operation 640, if it is determined in operation 620 that data having the same write address is not stored in the buffer, the controller determines whether to perform buffering using the buffer. In this case, the probability that the write address will be corrected is predicted using temporal proximity in the write address received in operation 610. If the probability the write address will be corrected is high, it is determined that buffering is to be performed using the buffer unit. If the probability the write address will be corrected is low, it is determined that buffering is not to be performed using the buffer unit.

In operation 650, if it is determined in operation 640 that the buffer will not be used, the controller writes the write data received in operation 610 according to the data writing method illustrated in FIG. 4. That is, the controller performs whole writing on a first storage medium or partial writing on a second storage medium, depending on whether data that is to be written is the same as data stored in the first storage medium.

In operation 660, if it is determined in operation 640 that buffering will be performed using the buffer, the controller determines whether the buffer has a space has a space to which the write data can be written.

In operation 670, if it is determined in operation 660 that the buffer has such a space, the write data is written to the buffer.

In operation 680, if the buffer does not have such a space, some of pieces of data stored in the buffer, which are infrequently used, are written using the data writing method illustrated in FIG. 4. That is, the controller performs whole writing on the first storage medium or partial writing on the second storage medium, depending on whether data that is to be written is the same as the data stored in the first storage medium.

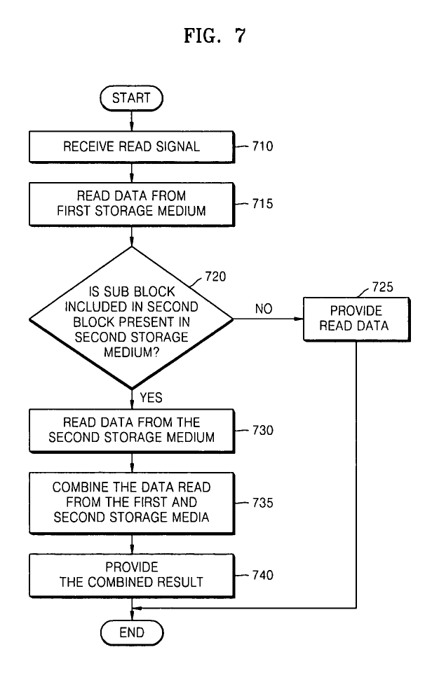

FIG. 7 is a flowchart illustrating a data reading method according to an embodiment of the present invention. Referring to FIG. 7, the data reading method of the present embodiment comprises operations that are sequentially performed by the data reading apparatus illustrated in FIG. 1C. Thus although not described here, the description of the data writing apparatus illustrated in FIG. 1C can be applied to the data writing method of FIG. 7.

In operation 710, a controller receives a read signal and a read address from a host.

In operation 715, after receiving the read signal and the read address in operation 710, the controller reads data stored at the read address of a first storage medium in response to the read signal. In this case, the controller 100 reads all data stored in a second block containing the read address.

In operation 720, the controller determines whether a sub block included in the second block is present in a second storage medium.

In operation 725, if it is determined in operation 720 that a sub block included in the second block is not present, the controller provides the host with the data read from the first storage medium.

In operation 730, if it is determined in operation 720 that a sub block included in the second block is present, the controller reads the data stored in the sub block from the second storage medium.

In operation 735, the controller combines the data read in operation 730 with the data read in operation 715 as illustrated in FIG. 3.

In operation 740, the controller transmits the combination result obtained in operation 735 to the host.

A comparison of the time required to perform a write operation in a data writing method according to the present invention with that of time required to perform a write operation in a conventional method reveals as follows.

First, since the time required to perform a write operation on flash memory is 300 μs, the time required to write data on a block is 300 μs according to a conventional method. These lengths of time are calculated based on the following assumption.

If a CPU of 100 MHz is used as a controller, 10 ns is incurred per cycle. Also, it is assumed that a block size is 2 Kbytes long (500 words), a sub block size is a quarter of the block size, i.e., 500 bytes long (125 words), flash memory is used as a first storage medium, and FRAM is used as a second storage medium. Then the time required to perform a read operation on the flash memory is 25 μs, and the time required to check a sub block whose data is different from write data and determine whether to perform partial writing is 2000 Bytes×10 ns=2000×10̂(−8)=20 μs. Also, in the case of FRAM, the time required for partial writing is 70 ns per word, and thus the time for writing to one sub block is 70 ns×25 words=7×10̂(−8)×125=8.75 μs (approximately, 9 μs). Accordingly, in the current embodiment, the time required for writing data to one block is 25 μs+20 μs+9 μs=54 μs.

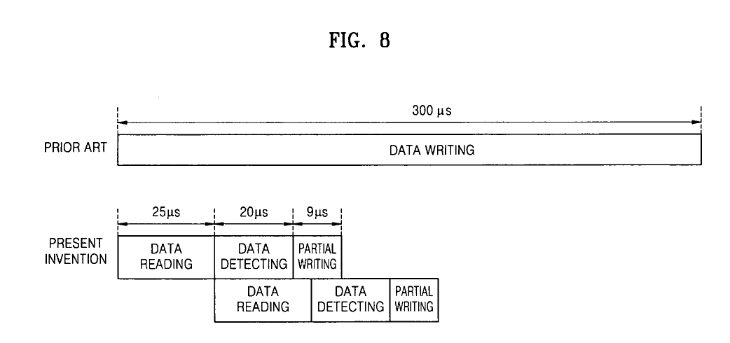

FIG. 8 is a diagram comparing the total length of time needed to perform a write operation when using a data writing method according to the present invention with a total length of time needed when using a conventional method. As illustrated in FIG. 8, if a write operation is continuously performed four times, 300 μs×4 (=1200 μs) is incurred according to the conventional method. However, according to the current embodiment, data reading or partial writing is performed using Direct Memory Access (DMA). Thus, it is possible to perform a read operation or partial writing operation even while the controller checks whether data stored in each sub block is the same as write data in order to select a sub block for partial writing. Thus, in this case, when a write operation is continuously performed 4 times, 25 μs×4+29 μs (=129 μs) is incurred. That is, the speed of performing the write operation according to the present invention is almost ten times faster than when using the conventional method.

The present invention can be embodied as computer readable code in a computer readable recording medium. Here, the computer readable medium may be any recording apparatus capable of storing data that is read by a computer system, e.g., a read-only memory (ROM), a random access memory (RAM), a compact disc (CD)-ROM, a magnetic tape, a floppy disk, an optical data storage device, and so on. Also, the computer readable medium may be a carrier wave that transmits data via the Internet, for example. The computer readable medium can be distributed among computer systems that are interconnected through a network, and the present invention may be stored and implemented as computer readable code in the distributed system.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of writing data, the method comprising:
receiving data that is to be written to a first storage medium, and an address of the first storage medium;
reading data stored at the address of the first storage medium;
comparing the received data with the read data; and
storing the received data in either the first storage medium or a second storage medium, depending on a comparison result;
wherein the first storage medium is a non-volatile storage medium supporting a block unit input/output operation and the second storage medium is the non-volatile storage medium supporting a unit input/output operation, wherein the unit is smaller than the block unit.

2. The method of claim 1, wherein during the comparing of the received data with the read data, first data different from the received data and a first address different from the received data are received and then data is read from the first address of the first storage medium.

3. The method of claim 1, wherein the comparing of the received data with the read data comprises:
dividing each of the received data and the read data into a plurality of sub blocks; and
detecting a sub block having different data by comparing data in respective sub blocks with one another.

4. The method of claim 3, wherein the storing of the received data comprises;
determining whether the sub block having different data satisfies a predetermined condition; and
storing the data stored in the sub block having different data in the second storage medium according to a determination result.

5. The method of claim 4, wherein the predetermined condition is that a total number of sub blocks detected is to be less than or equal to a threshold.

6. The method of claim 4, wherein the predetermined condition is that a total number of sub blocks detected is to be less than or equal to a first threshold or a total number of a series of sub blocks detected is less than or equal to a second threshold.

7. The method of claim 3, wherein the detecting of a sub block having different data comprises detecting a sub block having different data by comparing all data belonging to the sub block.

8. The method of claim 3, wherein the detecting of a sub block having different data comprises if a data difference is detected during comparison of all data belonging to a sub block, the sub block is detected while skipping comparing of the other data.

9. The method of claim 3, wherein the detecting of a sub block having different data comprises detecting a sub block having different data by calculating checksums of respective data belonging to the sub block and then comparing the checksums with one another.

10. A computer readable recording medium having recorded thereon a computer program for executing the method of claim 1.

11. A method of reading data, the method comprising:
if a request for data reading at an address is received from a host, reading data from a block of a first storage medium, which contains the address;
determining whether a second storage medium contains a sub block of the block containing the address;
reading data from the sub block of the second storage medium, depending on a determination result; and
combining the data from the first storage medium with the data read from the second storage medium and then providing a combination result to the host;
wherein the first storage medium is a non-volatile storage medium supporting a block unit input/output operation and the second storage medium is the non-volatile storage medium supporting a unit input/output operation, wherein the unit is smaller than the block unit.

12. The method of claim 11, wherein the combining of the data from the first storage medium with the data read from the second storage medium comprises combining the data from the first storage medium with the data read from the second storage medium, by using a mask.

13. An apparatus for writing data, comprising:
an input unit receiving data that is to be written to a first storage medium, and an address of the first storage medium;
a data reading unit reading data from the address of the first storage medium;
a comparison unit comparing the received data with the read data; and
a data writing unit writing the received data to either the first storage medium or a second storage medium, depending on a comparison result;
wherein the first storage medium is a non-volatile storage medium supporting a block unit input/output operation and the second storage medium is the non-volatile storage medium supporting a unit input/output operation, wherein the unit is smaller than the block unit.

14. The apparatus of claim 13, wherein the comparison unit divides each of the received data and the read data into a plurality of sub blocks; and compares data stored in the respective sub blocks in order to detect a sub block having different data.

15. The apparatus of claim 14, wherein the data writing unit determines whether the sub block having different data satisfies a predetermined condition, and then stores the data stored in the sub block having different data in the second storage medium, depending on the determining result.

16. The apparatus of claim 15, wherein the predetermined condition is that a total number of sub blocks detected is to be less than or equal to a threshold.

17. The apparatus of claim 15, wherein the predetermined condition is that a total number of sub blocks detected is to be less than or equal to a first threshold or a total number of a series of sub blocks detected is less than or equal to a second threshold.

18. An apparatus for reading data, comprising:
if a request for data reading at an address is received from a host, a first data reading unit reading data from a block of a first storage medium, which contains the address;
a determination unit determining whether a second storage medium contains a sub block of the block containing the address;
a second data reading unit reading data from the sub block of the second storage medium, depending on a determination result; and
a data combining unit combining the data read from the first storage medium with the data read from the second storage medium and then providing the combined result to the host;
wherein the first storage medium is a non-volatile storage medium supporting a block unit input/output operation and the second storage medium is the non-volatile storage medium supporting a unit input/output operation, wherein the unit is smaller than the block unit.
